(19) United States
(12) Patent Application Publication
(10) Pub. No.: US 2026/0321448 A1
(43) Pub. Date: Oct. 15, 2026

(54) METHODS AND SYSTEMS OF PARTITIONING, TRANSMUTING, AND RECYCLING USED NUCLEAR FUEL

(71) Applicant: Shine Technologies, LLC, Janesville, WI (US)

(72) Inventors: Ross Radel, Janesville, WI (US); Eric Van Abel, Janesville, WI (US); Gregory Piefer, Janesville, WI (US); Yana Karslyan, Janesville, WI (US)

(73) Assignee: Shine Technologies, LLC, Janesville, WI (US)

(21) Appl. No.: 19/484,129

(22) PCT Filed: May 16, 2024
(86) PCT No.: PCT/US2024/029747

§ 371 Date: Nov. 13, 2025

Related U.S. Application Data
(60) Provisional application No. 63/466,939, filed on May 16, 2023.

(51) Int. Cl. G21C 19/46; G21C 19/20; G21G 1/02

(52) U.S. Cl. CPC G21C 19/46; G21C 19/205; G21G 1/02

(57) ABSTRACT

A method of processing used nuclear fuel that includes voloxidizing used nuclear fuel pellets to form a used nuclear fuel powder dissolving the used nuclear fuel powder in a dissolution acid to form a main process stream extracting uranium (U), plutonium (Pu), neptunium (Np), and technetium (Tc) from the main process stream to form a first extraction stream, partitioning the first extraction stream into a U/Pu/Np stream and a U/Tc stream; partitioning the U/Pu/Np stream into Np and a U/Pu combination, partitioning one or more minor actinides and one or more lanthanides from the main process stream to form a second extraction stream, partitioning the one more minor actinides from the one or more lanthanides in the second extraction stream; and partitioning one or more noble metals from the main process stream.

### CROSS-REFERENCE TO RELATED APPLICATIONS

This application claims the benefit of U.S. Provisional Application No. 63/466,939 filed on May 16, 2023, which is incorporated herein by reference in its entirety.

### BACKGROUND

The present disclosure relates generally methods and systems of processing used nuclear fuel.

### SUMMARY

According to one embodiment of the present disclosure, a method of processing used nuclear fuel includes voloxidizing used nuclear fuel pellets to form a used nuclear fuel powder dissolving the used nuclear fuel powder in a dissolution acid to form a main process stream extracting uranium (U), plutonium (Pu), neptunium (Np), and technetium (Tc) from the main process stream to form a first extraction stream, partitioning the first extraction stream into a U/Pu/Np stream and a U/Tc stream; partitioning the U/Pu/Np stream into Np and a U/Pu combination, partitioning one or more minor actinides and one or more lanthanides from the main process stream to form a second extraction stream, partitioning the one more minor actinides from the one or more lanthanides in the second extraction stream; and partitioning one or more noble metals from the main process stream.

According to another embodiment of the present disclosure, method of processing used nuclear fuel includes combining a first organic extraction solution with a main process stream, the main process stream comprising used nuclear fuel; agitating the main process stream and the first organic extraction solution using a solvent extraction system such that a first extraction stream is partitioned from the main process stream, wherein the first extraction stream comprises the first organic extraction solution and a first extracted solvent combination, the first extracted solvent combination comprising uranium (U), plutonium (Pu), neptunium (Np), and technetium (Tc); partitioning the first extraction stream, wherein partitioning the first extraction stream comprises: adding a first aqueous removal agent to the first extraction stream and agitating the first extraction stream with the solvent extraction system such that the first extraction stream partitions into a U/Pu/Np aqueous solution and a U/Tc organic solution; adding additional first organic extraction solution and a second aqueous removal agent to the U/Pu/Np aqueous solution and agitating the U/Pu/Np aqueous solution with the solvent extraction system such that the U/Pu/Np solution partitions into a U/Pu organic solution and an Np aqueous solution; directing a nitric acid solution into the U/Tc organic solution and agitating the U/Tc organic solution with the solvent extraction system such that the U/Tc organic solution partitions into a U/Tc aqueous solution; and partitioning the U/Tc aqueous solution into U and Tc.

According to yet another embodiment of the present disclosure, a method of processing used nuclear fuel includes combining a first organic extraction solution with a main process stream, the main process stream comprising used nuclear fuel; agitating the main process stream and the first organic extraction solution using a solvent extraction system such that a first extraction stream is separated from the main process stream, wherein the first extraction stream comprises the first organic extraction solution and a first extracted solvent combination, the first extracted solvent combination comprising uranium (U), plutonium (Pu), neptunium (Np), and technetium (Tc); partitioning the first extraction stream, wherein partitioning the first extraction stream comprises: adding a first aqueous removal agent to the first extraction stream and agitating the first extraction stream with the solvent extraction system such that the first extraction stream separates into a U/Pu/Np aqueous solution and a U/Tc organic solution; adding additional first organic extraction solution and a second aqueous removal agent to the U/Pu/Np aqueous solution and agitating the first extraction stream with the solvent extraction system such that the U/Pu/Np solution separates into a U/Pu organic solution and an Np aqueous solution; directing a nitric acid solution into the U/Tc organic solution and agitating the U/Tc organic solution with the solvent extraction system such that the U/Tc organic solution separates into a U/Tc aqueous solution; and interacting the U/Tc aqueous solution with an ion exchange column such that Te adsorbs onto an ion exchange material of the ion exchange column, the method further including combining a second organic extractant solution with the main process stream and agitating the main process stream using the solvent extraction system such that a second extraction stream is separated from the main process stream, wherein the second extraction stream comprises the second organic extractant solution and a second extracted solvent combination, the second extracted solvent combination comprising one or more actinides and one or more lanthanides; partitioning the one or more actinides from the second extraction stream; partitioning the one or more lanthanides from the second extraction stream; and partitioning one or more noble metals from the main process stream.

Additional features and advantages will be set forth in the detailed description which follows, and in part will be readily apparent to those skilled in the art from that description or recognized by practicing the embodiments described herein, including the detailed description which follows, the claims, as well as the appended drawings.

It is to be understood that both the foregoing general description and the following detailed description describe various embodiments and are intended to provide an overview or framework for understanding the nature and character of the claimed subject matter. The accompanying drawings are included to provide a further understanding of the various embodiments, and are incorporated into and constitute a part of this specification. The drawings illustrate the various embodiments described herein, and together with the description serve to explain the principles and operations of the claimed subject matter.

### BRIEF DESCRIPTION OF THE DRAWINGS

FIG. 1 schematically depicts an embodiment of a fuel processing system comprising a shearing system, a voloxidation system, a dissolution system, and a solvent extraction system, according to embodiments disclosed and described herein;

FIG. 2 schematically depicts a uranium extraction subsystem and a fission product extraction subsystem of the solvent extraction system of FIG. 1, according to embodiments disclosed and described herein;

FIG. 3 schematically depicts an actinide extraction subsystem and a downstream metal extraction subsystem of the solvent extraction system of FIG. 1, according to embodiments disclosed and described herein;

FIG. 4 schematically depicts a transmutation system comprising a beam accelerator, according to embodiments disclosed and described herein; and

FIG. 5 schematically depicts a transmutation system comprising a reactor, according to embodiments disclosed and described herein.

### DETAILED DESCRIPTION

Reference will now be made in detail to embodiments of used nuclear fuel processing, which may include the partitioning, transmuting, and recycling of components of used nuclear fuel, embodiments of which are illustrated in the accompanying drawings. The used nuclear fuel processing methods described herein include uranium/plutonium co-extraction processes to partition used nuclear fuel into uranium, uranium/plutonium, neptunium, technetium, minor actinides (e.g., americium and curium), lanthanides, and fission products using liquid-to-liquid extraction, ion exchange extraction, and combinations thereof. The used nuclear fuel processing methods described herein may also include one or more transmutation processes (e.g., fusion based transmutation) that include irradiating separation products, such as the minor actinides. Whenever possible, the same reference numerals will be used throughout the drawings to refer to the same or like parts.

There are greater than 86,000 tons of used nuclear fuel in temporary storage at nuclear power plants across America. Presently, there is no actionable plan for long-term management of this waste, which grows at a present rate of approximately 2.5% per year. This rate will increase as nuclear energy production increases in an effort to offset climate change. Without new economically and environmentally viable solutions, nuclear waste will continue to hold back the progress of nuclear energy and will be an ongoing economic burden. The used nuclear fuel processing methods described herein are designed to address nuclear waste disposal problems and reduce the environmental impact of nuclear energy generation through the recycling and transmutation of used nuclear fuel. These used nuclear fuel processing methods are designed to reduce the longevity and long-term radiotoxicity of high-level waste and improve reprocessing economics via value-added isotope extraction. The synergy between reprocessing and transmutation technologies contemplated herein enable a holistic solution to the used nuclear fuel disposal challenge and provide increase cost effectiveness compared to previous technologies.

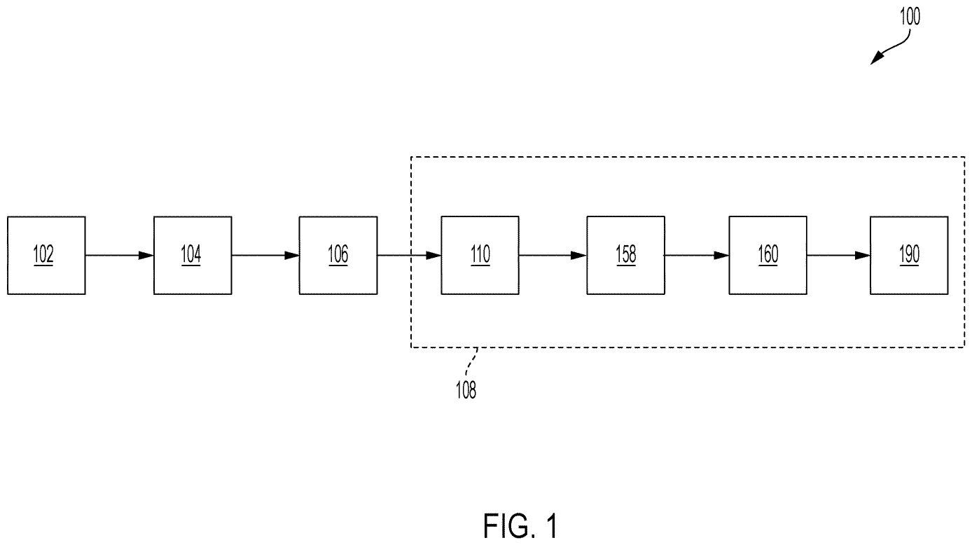

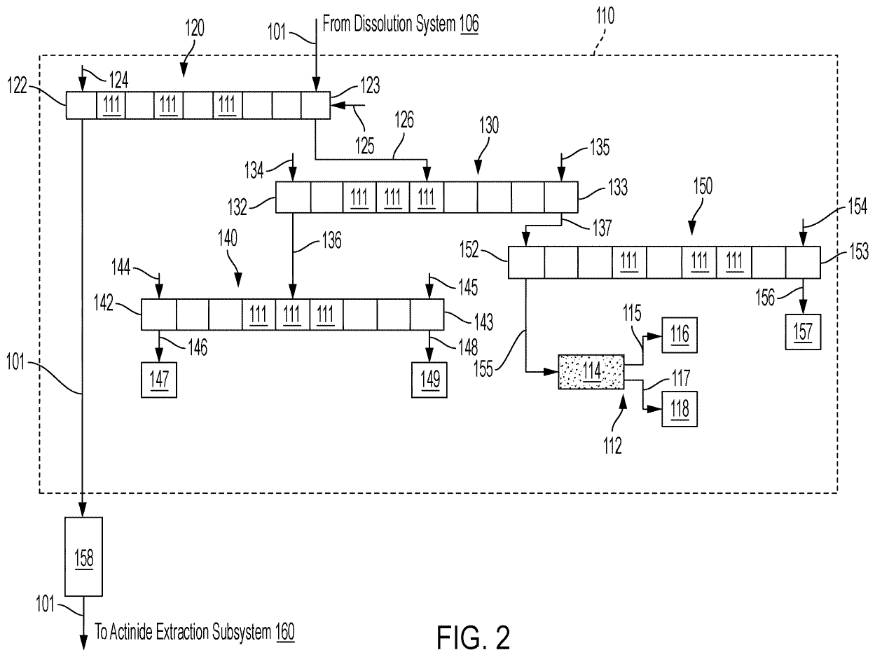

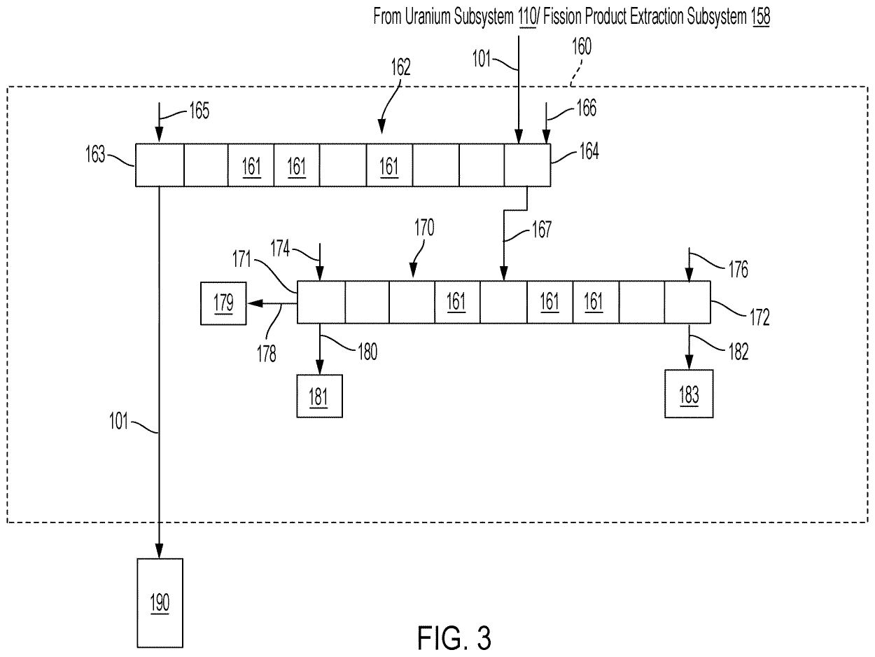

Referring now to FIG. 1, a fuel processing system 100 is schematically depicted. The fuel processing system 100 is configured to process used nuclear fuel, for example, to partition, transmute, and recycle components of used nuclear fuel As depicted in FIG. 1, the fuel processing system 100 comprises a fuel rod shearing system 102, a voloxidation system 104, a dissolution system 106, and a solvent extraction system 108. As shown schematically in FIG. 1, the solvent extraction system 108 comprises several subsystems each configured to selectively extract different subsets of the elements present in used nuclear fuel. For example, the solvent extraction system 108 may comprise a uranium extraction subsystem 110 configured to selectively extract or co-extract uranium, plutonium, neptunium, and technetium from a main process stream 101 (FIGS. 2 and 3), a fission product extraction subsystem 158, configured to selectively extract cesium and strontium from the main process stream 101, an actinide extraction subsystem 160 configured to selectively extract minor actinides and lanthanides from the main process stream 101, and a downstream metal extraction subsystem 190 configured to selectively extract noble metals from the main process stream 101.

Referring still to FIG. 1, the fuel rod shearing system 102 is configured to separate the end fittings of a nuclear fuel rod bundle of used nuclear fuel and to cut the used nuclear fuel rods into segments sized to facilitate voloxidation of the materials inside the cladding of the nuclear fuel rods. Indeed, the fuel rod shearing system 102 is configured to shear used nuclear fuel rods into pellets of used nuclear fuel and cladding hulls. The fuel rod shearing system 102 comprises one or more shearing devices. The voloxidation system 104 comprises a voloxidation furnace and an off-gas system. The off-gas system is fluidly coupled to the voloxidation furnace and is configured to capture gases released by heating the used nuclear fuel pellets and hulls in the voloxidation furnace. In operation, the voloxidation furnace heats the sheared pellets and hulls to a temperature in a range of from 300 °C to 650 °C. In some embodiments, NO₂, O₂, air, and H₂O are present in the voloxidation furnace during the heating process. Voloxidation converts the uranium dioxide (UO₂) the used nuclear fuel pellets to triuranium octoxide (U₃O₈) or uranium trioxide (UO₃). Voloxidation also alters the crystal structure of the used nuclear fuel pellets. Without intending to be limited by theory, the conversion of UO₂ to U₃O₈ or UO₃ causes the used nuclear fuel to undergo a structural change in which its crystal form changes from a cubic structure to an orthorhombic structure. This structural change also converts the used nuclear fuel material from solid pellets and pellet fragments to a coarse powder form. This increase in surface area and the altered uranium oxidation state caused by voloxidation results in a nuclear fuel material that dissolves more readily in acid (e.g., in nitric acid) in the subsequent dissolution process performed by the dissolution system 106.

During voloxidation, the change in crystal structure of the used nuclear fuel and the elevated temperature causes additional volatile fission products (e.g., separation products) to be released for collection, such as tritium and iodine (e.g., ¹²⁹I). During voloxidation, tritium is released as tritiated water (HTO) which may be captured on a hydrophilic sorbent such as molecular sieves, zeolite beds, or a combination thereof. ¹²⁹I is also released during the voloxidation, especially when NO₂ is utilized, and may be captured using a zeolite bed, caustic scrubber, molecular sieves, or a combination thereof. Other volatile fission products, such as xenon (Xe), krypton (Kr), e.g., ⁸⁵Kr, and carbon-14(¹⁴CO₂) are removed both during voloxidation and the subsequent dissolution process. The ¹⁴CO₂ can be captured using caustic scrubbers, molecular sieves, zeolite beds, or a combination thereof. The Kr and Xe are also released during dissolution and may be captured on a chilled adsorbent material, such as a zeolite, charcoal, a metal organic framework material.

Referring still to FIG. 1, the dissolution system 106 comprises a dissolution tank for dissolving the now powdered used nuclear fuel in a dissolution acid, such as nitric acid. In some embodiments, the dissolution system 106 also comprises a buffer tank, which may be fluidly coupled to the dissolution tank. After voloxidation, the powdered used nuclear fuel and hulls are transferred to the dissolution tank of the dissolution system 106 and dissolved in the dissolution acid, clarifying the dissolved used nuclear fuel from undissolved metallics, such as cladding dust and fission product particles and inclusions (e.g., fission products that do not dissolve together with the remaining used nuclear fuel). The dissolved used nuclear fuel is then moved to the buffer tank and the separated hulls and metallic particulate are rinsed and collected for disposal. Separating the hulls removes tritium present in the hulls from the used nuclear fuel. Without intending to be limited by theory, by removing volatiles from the used nuclear fuel in the front end of the used nuclear fuel separation process (e.g., using the voloxidation system 104 and the dissolution system 106), the amount of activity that is absorbed into the process water and nitric acid downstream (e.g., in the main process stream 101) is greatly reduced. Since process water ends up dispersed throughout the plant, the volume of contaminated water, including tritium contamination, that must be treated or eventually disposed is greatly reduced which reduces operational cost and potential release to the environment.

Referring now to FIGS. 1-3, the solvent extraction system 108 may comprises several subsystems each configured to partition selective portions of the used nuclear fuel for storage or further processing. The uranium extraction subsystem 110 comprises one or more extraction banks (e.g., extraction banks 120, 130, 140, 150) and is configured to selectively extract or co-extract uranium, plutonium, neptunium, and technetium from the main process stream 101 using liquid-liquid extraction techniques. Each extraction bank comprises a first end and a second end and a plurality of mixing devices 111 positioned between the first end and the second end. The mixing devices 111 of each extraction bank may be fluidly coupled to one another and arranged in series. It should be understood that a select number of the mixing devices 111 are numbered in FIG. 2 for ease of review. It should also be understood that while nine mixing devices 111 are depicted in each extraction bank in FIG. 2, any number of mixing devices 111 are contemplated. Indeed, embodiments are contemplated in which the extraction banks may have differing numbers of mixing devices. In operation, the mixing devices induce reactions between elements in an acidic liquid (i.e., in an aqueous phase) and elements in an organic liquid (i.e., in an organic phase). The plurality of mixing devices 111 may comprise centrifugal contactors, pulse columns, mixer settlers, or combinations thereof. In some embodiments, centrifugal contactors are useful because their compact size allows for the use of smaller hot cells, reducing the capital cost required for facility construction.

Referring now to FIG. 2, the uranium extraction subsystem 110 includes a first extraction bank 120 comprising a first end 122 opposite a second end 123, and a plurality of mixing devices 111. The main process stream 101 is fluidly coupled to the first extraction bank 120, for example, to a mixing device 111 at or near the second end 123. The first extraction bank 120 further comprises an organic input 124 and an aqueous input 125. The organic input 124 is a fluid pathway for organic solution to be directed into the first extraction bank 120 and the aqueous input 125 is a fluid pathway for aqueous solution to be directed into the first extraction bank 120. The organic input 124 and the aqueous input 125 may comprise any fluid flow and control devices, such as piping, tubing, pumps, and tanks. In some embodiments, the organic input 124 is positioned at or near the first end 122 and the aqueous input 125 is positioned at or near the second end 123. In some embodiments, the aqueous input 125 is positioned closer to the input of the main process stream 101 into the first extraction bank 120 than the organic input 124.

In operation, the main process stream 101 of used nuclear fuel is directed into the first extraction bank 120 and a first organic extraction solution is combined with the main process stream 101 in the first extraction bank 120. For example, the main process stream 101 is directed into the first extraction bank 120 at the second end 123 of the first extraction bank 120 and the first organic extraction solution is directed into the first end 122 of the first extraction bank 120 at the organic input 124. The plurality of mixing devices 111 of the first extraction bank 120 direct the main process stream 101 from the second end 123 toward the first end 122 and direct the first organic extraction solution from the first end 122 toward the second end 123, combining and agitating the first extraction solution and the main process stream 101 using the mixing devices 111 such that certain elements are removed from the main process stream 101 (which is in a aqueous phase) and combined with the first extraction solution (which is an organic phase) to form a first extraction stream. The first organic extraction solution comprises an organo-phosphorus extractant and a hydrocarbon diluent. For example, the organo-phosphorus extractant may comprise tributyl phosphate (TBP) and the hydrocarbon diluent may comprise a dodecane such as n-dodecane diluent or other hydrocarbons, for example, C10-C20, paraffin, kerosene, or any other hydrocarbon that dilutes TBP, such as dodecane, hydrogenated tetra-propelene, Hyfrane 120, Soltrol 170 or Isopar-L. In some embodiments, the TBP comprises from 20% to 40% of the first organic extraction solution, for example 25%, 30%, or 35% of the first organic solution, or any value in a range having two of those values as endpoints. Without intending to be limited by theory, Pu has a chemical affinity for this TBP formed organic phase, facilitating separation using the mixing devices 111. The first extraction stream comprises the first organic extraction solution and a first extracted solvent combination, which comprising uranium (U), plutonium (Pu), neptunium (Np), and technetium (Tc). The formation of the first extraction stream partitions U, Pu, Np, and Tc from the main process steam, which remains in aqueous phase and exits the first extraction bank 120 at the first end 122 and is directed to the additional subsystems the solvent extraction system 108.

In some embodiments, additional aqueous solution may be directed into the first extraction bank 120, for example, from the aqueous input 125 to filter out unwanted materials, for example, from the first extraction stream. These additional infusions of aqueous solution may be referred to as scrubs and remove elements that co-extract with U, Pu, Np, and Tc, such as ruthenium, molybdenum, and zirconium. In some embodiments, a first scrub of higher concentration nitric acid is directed into the first extraction bank 120, for example, nitric acid in a molar range of 4.5 M to 6.5 M, for example 5 M to 6 M, such as 5.5 M, which may be followed by a second scrub of lower nitric acid, such as nitric acid in a molar range of 0.15 M to 0.35 M for example 0.2 M to 0.3 M, such as 0.25 M. It should be understood that such scrubs may be done after partitioning in each extraction bank of the uranium extraction subsystem 110.

The first extraction stream remains in organic phase, exits the first extraction bank 120 at the second end 123 and is directed to a second extraction bank 130 via a feed path 126, which fluidly couples the first extraction bank 120 and the second extraction bank 130. The second extraction bank 130 comprises a first end 132 opposite a second end 133, and a plurality of mixing devices 111. The feed path 126 is fluidly coupled to the second extraction bank 130, for example, to a mixing device 111 between the first end 132 and the second end 133, for example, at or near the center of the second extraction bank 130. The second extraction bank 130 further comprises an organic input 134 and an aqueous input 135. The organic input 134 is a fluid pathway for organic solution to be directed into the second extraction bank 130 and the aqueous input 135 is a fluid pathway for aqueous solution to be directed into the second extraction bank 130. The organic input 134 and the aqueous input 135 may comprise any fluid flow and control devices, such as piping, tubing, pumps, and tanks. In some embodiments, the organic input 134 is positioned at or near the first end 132 and the aqueous input 135 is positioned at or near the second end 133.

In operation, the first extraction stream is directed into the second extraction bank 130 and a first aqueous removal agent is combined with the first extraction stream in the second extraction bank 130. For example, the first extraction stream is directed into the second extraction bank 130 between the first end 132 and the second end 133 and the first aqueous removal agent is directed into the second end 133 of the second extraction bank 130 at the aqueous input 135. In some embodiments, additional organic extraction solution is directed into the first end 132 of the second extraction bank 130, for example, at the organic input 134. The plurality of mixing devices 111 of the second extraction bank 130 direct the first extraction stream and any additional organic solution toward the second end 133 and direct the first aqueous removal agent toward the first end 132, combining and agitating the first aqueous removal agent and the first extraction stream using the mixing devices 111 such that certain elements are removed from the first extraction stream (which is in an organic phase) and combined with the first aqueous removal agent (which is an aqueous phase). In some embodiments, the first aqueous removal agent comprises nitric acid and one or more oxidation state modifiers. The one or more oxidation state modifiers of the first aqueous removal agent comprise U(IV) and N₂H₅NO₃. For example, the U(IV) is present in the first aqueous removal agent in a molar range of from 0.02 M to 0.2 M and the N₂H₅NO₃ is present in the first aqueous removal agent in a molar range of from 0.05 to 0.3 M.

In some embodiments, a combination of U, Pu, and Np combine with the first aqueous removal agent to form a U/Pu/Np aqueous solution and a combination of U and To remain in the first extraction stream, forming a U/Tc organic solution. Without intending to be limited by theory, some of the U remains with Tc in the aqueous phase and some of the U converts to aqueous phase with the Pu/Np because of the relative chemical affinity of each of the Tc, U, Pu, and Np for the organic extraction solution, namely the TBP. Under the conditions present in the second extraction bank 130 when combining the first aqueous removal agent and the first extraction stream, Tc has the highest chemical affinity for the organic extraction solution, followed by U, which has a higher chemical affinity for the organic extraction solution than Pu and Np. Thus, the Tc remains in organic phase when combining and agitating the first aqueous removal agent and the first extraction stream and the operation can be tuned such that some of the U remains in organic phase with the Tc and some of the U remains in aqueous phase with the with the Np and the Pu, such that Pu can be co-extracted with U. For example, the relative flow rate of the first aqueous removal agent and the first extraction stream may be such that interaction therebetween causes removal of all the Pu, Np, and some of the U into the aqueous phase. For example, the relative flow rate may be greater than 17 mL/min.

The U/Pu/Np aqueous solution exits the second extraction bank 130, for example, at the first end 132, and is directed to a third extraction bank 140 via a feed path 136 for additional processing at the third extraction bank 140. The U/Tc organic solution exits the second extraction bank 130, for example, at the second end 133, and is directed to a fourth extraction bank 150 via a feed path 137 for additional processing at the fourth extraction bank 150. In some embodiments, additional aqueous solution may be directed into the second extraction bank 130, for example, from the aqueous input 135 to filter out unwanted materials in one or more scrub steps. In some embodiments, a first scrub of higher concentration nitric acid is directed into the second extraction bank 130, for example, nitric acid in a molar range of 4.5 M to 6.5 M, for example 5 M to 6 M, such as 5.5 M, which may be followed by a second scrub of lower nitric acid, such as nitric acid in a molar range of 0.15 M to 0.35 M for example 0.2 M to 0.3 M, such as 0.25 M.

The third extraction bank 140 comprises a first end 142 opposite a second end 143, and a plurality of mixing devices 111. The feed path 136 is fluidly coupled to the third extraction bank 140, for example, to a mixing device 111 between the first end 142 and the second end 143, for example, at or near the center of the third extraction bank 140. The third extraction bank 140 further comprises an organic input 144 and an aqueous input 145. The organic input 144 is a fluid pathway for organic solution to be directed into the third extraction bank 140 and the aqueous input 145 is a fluid pathway for aqueous solution to be directed into the third extraction bank 140. The organic input 144 and the aqueous input 145 may comprise any fluid flow and control devices, such as piping, tubing, pumps, and tanks. In some embodiments, the organic input 144 is positioned at or near the first end 142 and the aqueous input 145 is positioned at or near the second end 143. The third extraction bank 140 further comprises a collection pathway 146 fluidly coupling one or more mixing devices 111 positioned at or near the first end 142 to a collection unit 147 and a collection pathway 148 fluidly coupling one or more mixing devices 111 positioned at or near the second end 143 to a collection unit 149.

In operation, the U/Pu/Np aqueous solution is directed into the third extraction bank 140 and a second aqueous removal agent is combined with the U/Pu/Np aqueous solution in the third extraction bank 140. For example, the U/Pu/Np aqueous solution is directed into the third extraction bank 140 between the first end 142 and the second end 143, the second aqueous removal agent is directed into the second end 143 of the third extraction bank 140 at the aqueous input 145, and additional first organic extraction solution is directed into the first end 142 of the third extraction bank 140, for example, at the organic input 144. The plurality of mixing devices 111 of the third extraction bank 140 direct the U/Pu/Np aqueous solution and additional first organic extraction solution toward the second end 143 and direct the second aqueous removal agent toward the first end 142, combining and agitating the second aqueous removal agent, additional first organic extraction solution, and the U/Pu/Np aqueous solution using the mixing devices 111 such that certain elements are removed from the U/Pu/Np aqueous solution (which is in an aqueous phase) and combined with the additional first organic extraction solution (which is an organic phase). Indeed, a combination of U and Pu combine with the additional first organic extraction solution to form a U/Pu organic solution and the Np remans in aqueous phase, forming an Np aqueous solution.

The second aqueous removal agent comprises nitric acid and one or more oxidation state modifiers. In some embodiments, the one or more oxidation state modifiers of the second aqueous removal agent comprise U(IV) and N₂H₅NO₃. For example, the U(IV) is present in the second aqueous removal agent in a molar range of from 0.05 M to . 15 M, for example 0.1 M and the N₂H₅NO₃ is present in the second aqueous removal agent in a molar range of from 0.05 to 0.3 M. In such embodiments, the molar concentration of the U(IV) and/or the N₂H₅NO₃ in the second aqueous removal agent are higher than the molar concentration of the U(IV) and/or the N₂H₅NO₃ in the first aqueous removal agent. In some embodiments, the one or more oxidation state modifiers of the second aqueous removal agent comprise V(V) and FeSO₄.

The U/Pu organic solution exits the third extraction bank 140, for example, at the first end 142, and is directed to a collection unit 147 via a collection pathway 146 for storage and, in some embodiments, additional processing. The U/Pu remains co-extracted through the used nuclear fuel partitioning process. For example, the U/Pu organic solution may comprise a range of from 18-40% Pu and from 60-82% Pu. These amounts of U and Pu in the U/Pu organic solution is tunable based on the redox chemistry of the organic and aqueous solutions introduced during the partitioning process and the relative flow rates of the solutions, for example, when partitioning the U/Pu/Np from U/Tc and when partitioning U/Pu from Np. The U/Pu may be further processed. For example, the U/Pu organic solution can be stripped into the aqueous phase (e.g., into a U/Pu aqueous solution) with additional nitric acid, and the de-nitrified of the nitric acid, for example, by calcination or precipitation. Calcinating may comprise heating the U/Pu aqueous solution to about 200 °C or greater, to remove the nitrate. By removing the nitrate, the stripped U/Pu can be turned into an oxide stream. The U/Pu oxide stream could be used directly in nuclear fuel production. The Np aqueous solution exits the third extraction bank 140, for example, at the second end 143, and is directed to a collection unit 149 via a collection pathway 148 for storage and, in some embodiments, additional processing. For example, the Np aqueous solution may be de-nitrified of the nitric acid, for example, by calcination or precipitation. Calcinating may comprise heating the Np aqueous solution to about 200 °C or greater, to remove the nitrate. Isolating Np allows the Np, which is primarily present in used nuclear fuel as Np-237, to later be used as feedstock to produce Pu-238.

The fourth extraction bank 150 comprises a first end 152 opposite a second end 153, and a plurality of mixing devices 111. The feed path 137 is fluidly coupled to the fourth extraction bank 150, for example, to a mixing device 111 at or near the first end 152. The fourth extraction bank 150 further comprises an aqueous input 154, which is a fluid pathway for aqueous solution to be directed into the fourth extraction bank 150. The aqueous input 154 may comprise any fluid flow and control devices, such as piping, tubing, pumps, and tanks. In some embodiments, the aqueous input 154 is positioned at or near the second end 153. The fourth extraction bank 150 further comprises a collection pathway 156 fluidly coupling one or more mixing devices 111 positioned at or near the second end 153 to a collection unit 157. In addition, a feed path 155 fluidly couples the fourth extraction bank 150, for example, a mixing device 111 at or near the first end 152 with an ion exchange system 112. The ion exchange system 112 comprises an ion exchange column 114 containing one or more ion exchange resins configured to selectively adsorb material.

In operation, the U/Tc organic solution is directed into the fourth extraction bank 150 and a nitric acid solution is combined with the U/Tc organic solution in the fourth extraction bank 150. For example, the U/Tc organic solution is directed into the fourth extraction bank 150 at the first end 152 and the nitric acid solution is directed into the second end 153 of the fourth extraction bank 150 at the aqueous input 154. The plurality of mixing devices 111 of the fourth extraction bank 150 direct the U/Tc organic solution and toward the second end 153 and direct the nitric acid solution toward the first end 152, combining and agitating the nitric acid solution and the U/Tc organic solution using the mixing devices 111 such that U and Tc are removed from the U/Tc organic solution (which is in an organic phase) and combined with the nitric acid solution (which is an aqueous phase) to form a U/Tc aqueous solution and a remainder organic solution. The U/Tc aqueous solution exits the fourth extraction bank 150, for example, at the first end 152, and is directed to an ion exchange column 114 via a feed path 155. The remainder organic solution exits the fourth extraction bank 150, for example, at the second end 153, and is directed to a collection unit 157 via a collection pathway 156 for storage and, in some embodiments, additional processing. In some embodiments, the nitric acid is a dilute nitric acid comprising a molarity in a range of from 0.1 M to 1 M or a strong nitric acid comprising a molarity in a range of from 1 M to 5 M. In some embodiments U and Te is stripped into aqueous solution with two steps of combining nitric acid with the U/Tc organic solution, for example, the dilute nitric acid may first be combined with the U/Tc organic solution and then the strong nitric acid may be combined with the remaining U/Tc organic solution thereafter.

The U/Tc aqueous solution is directed to the feed path 155 to the ion exchange column 114. The ion exchange column 114 comprises an anion exchange resin, such as Reillex HPQ resin or Rilex HP resins, which adsorbs Tc from the U/Tc aqueous solution, allowing the remaining U aqueous solution to be collected. For example, the remaining U aqueous solution may exit the ion exchange column 114 and flow from the ion exchange column 114 to a collection unit 116 along a collection pathway 115 for collection and further processing. After collection, the U may be separated from the U aqueous solution by de-nitrating the U, for example, by calcination or precipitation, to remove the nitric acid. Calcinating may comprise heating the U aqueous solution to about 200 °C or greater, to remove the nitrate. The Tc can be resorbed from ion exchange column 114 using nitric acid, forming a Tc aqueous solution which may exit the ion exchange column 114 and flow from the ion exchange column 114 to a collection unit 118 along a collection pathway 117 for collection and further processing. After collection, the Tc may be separated from the Tc aqueous solution by de-nitrating the Tc, for example, by calcination or precipitation, to remove the nitric acid. Calcinating may comprise heating the Tc aqueous solution to about 200 °C or greater, to remove the nitrate. While FIG. 2 depicts an ion exchange column 114 for partitioning of U and Te, it should be understood that embodiments are contemplated in which U and Te are partitioned using liquid-liquid extraction, for example, using one or more additional extraction banks each comprising mixing devices similar to the extraction banks and the mixing devices described above with respect to the uranium extraction subsystem 110. By removing the nitrate, the stripped U can be turned into an oxide stream. The U oxide stream could then undergo an enrichment process, for example, at an enrichment facility, and thereafter be used in nuclear fuel production.

Referring still to FIG. 2, the fission product extraction subsystem 158 is configured to selectively extract cesium and strontium from the main process stream 101. Cesium and strontium, particularly Cs-137 and Sr-90, produce a large amount of the radioactive dose present in the main process stream. Thus, removing cesium and strontium with the fission product extraction subsystem 158 improves downstream separation and collection processes because removing cesium and strontium reduces radiation dose and decay heat on the downstream components, such as components of the actinide extraction subsystem 160 and the downstream metal extraction subsystem 190, reducing the radiation shielding need and reducing the dose to the chemical separation equipment and molecules. Indeed, minor actinide/lanthanide partitioning using the actinide extraction subsystem 160 relies on complicated molecules that are often fragile under high doses of radiation and heat load, thus removing the cesium and strontium may increase the efficiency and effectiveness of the minor actinide/lanthanide partitioning process.

In some embodiments, the fission product extraction subsystem 158 comprises a liquid-liquid extraction system. For example, the fission product extraction subsystem 158 may comprise one or more extraction banks each comprising mixing devices similar to the extraction banks and the mixing devices described above with respect to the uranium extraction subsystem 110. In operation, strontium and cesium present in a nitric acid medium (e.g., present in the main process stream 101 exiting the first extraction bank 120 of the uranium extraction subsystem 110) by be selectively extracted from the main process stream 101 using organic extractants that have a chemical affinity for strontium and cesium, for example, combined crown ethers and calixarenes. For example, strontium may be extracted using an organic extractant comprising 4,4′(5′)-di-t-butylcyclohexano 18-crown-6 and cesium may be extracted using an organic extractant comprising calix[4]arene-crown ethers.

In some embodiments, the fission product extraction subsystem 158 comprises an ion exchange system configured to extract cesium (e.g., Cs-137) and strontium (e.g., Sr-90) from the main process stream 101 via adsorption. For example, the fission product extraction subsystem 158 may comprise an ion exchange column and extracting cesium and strontium from the main process stream 101 comprises contacting the main process stream 101 with one or more ion exchange resins, such as cation exchange resins, such that the cesium and strontium adsorb onto the ion exchange resins. The cation exchange resin may be polymer based and may be housed in one or more columns. The cation exchange resin may comprise a strong acid cation exchange resin with a combination of porosity, which contributes to the adsorption capacity, and chemical functionality, which contributes to selectivity. Example cation exchange resins include SACMP (Strong Acid Cation Macroporous Polystyrene) resin (such as ResinTech® SACMP, manufactured by ResinTech Inc.) and AMP-PAN (Ammonium Molybophosphate Polyacrylonitrile) resin.

Referring now to FIG. 3, the main process stream 101 is now directed to the actinide extraction subsystem 160. When the main process stream 101 reaches the actinide extraction subsystem 160, the minor actinides and the lanthanides are a significant portion of the remaining used nuclear fuel (e.g., the remaining main process stream 101). The actinide extraction subsystem 160 is liquid-liquid extraction system configured to separate trivalent americium (Am) and curium (Cm) from the lanthanides and transition metal fission products. The actinide extraction subsystem 160 includes a first extraction bank 162 comprising a first end 163 opposite a second end 164, and a plurality of mixing devices 161. Like the mixing devices 111 of FIG. 2, the plurality of mixing devices 161 may comprise centrifugal contactors, pulse columns, mixer settlers, or combinations thereof. The main process stream 101 is fluidly coupled to the first extraction bank 162, for example, to a mixing device 161 at or near the second end 164. The first extraction bank 162 of the actinide extraction subsystem 160 further comprises an organic input 165 and an aqueous input 166. The organic input 165 is a fluid pathway for organic solution to be directed into the first extraction bank 162 and the aqueous input 166 is a fluid pathway for aqueous solution to be directed into the first extraction bank 120. The organic input 165 and the aqueous input 166 may comprise any fluid flow and control devices, such as piping, tubing, pumps, and tanks. In some embodiments, the organic input 165 is positioned at or near the first end 163 and the aqueous input 166 is positioned at or near the second end 164. In some embodiments, the aqueous input 125 is positioned closer to the input of the main process stream 101 into the first extraction bank 120 than the organic input 124.

In operation, the main process stream 101 of used nuclear fuel is directed into the first extraction bank 162 of the actinide extraction subsystem 160. This occurs after the U, Pu, Np, and Tc are partitioned from the main process stream 101 using the uranium extraction subsystem 110 and, in some embodiments, after the cesium and strontium are partitioned from the main process stream 101 using the fission product extraction subsystem 158. A second organic extraction solution is combined with the main process stream 101 in the first extraction bank 162 of the actinide extraction subsystem 160. For example, the main process stream 101 is directed into the first extraction bank 162 at the second end 164 of the first extraction bank 162 and the second organic extraction solution is directed into the first end 163 of the first extraction bank 162 at the organic input 165. The plurality of mixing devices 161 of the first extraction bank 162 direct the main process stream 101 from the second end 164 toward the first end 163 and direct the second organic extraction solution from the first end 163 toward the second end 164, combining and agitating the second extraction solution and the main process stream 101 using the mixing devices 161 such that certain elements are removed from the main process stream 101 (which is in a aqueous phase) and combined with the second extraction solution (which is an organic phase) to form a second extraction stream. The second organic extraction solution comprises an organic neutral extractant and an acidic extractant dissolved in an aliphatic diluent (e.g., n-dodecane). The organic neutral extractant may comprise a neutral diglycolamide extractant. Example organic neutral extractants include such as N,N,N′,N′-tetra(2-ethylhexyl)diglycolamide (T2EHDGA) or N,N,N′,N′-tetraoctyldiglycolamide (TODGA), N,N′-dimethyl-N,N′-dioctylhexylethoxymalonamide (DMODOHEMA), and n-Octyl (phenyl)-N, N-diisobutylcarbamoylmethylphosphine oxide (CMPO). Example acidic extractants include 2-ethylhexylphosphonic acid mono-2-ethylhexyl ester (HEH[EHP]) and Di(2-ethylhexyl)phosphoric acid (HDEHP).

The second extraction stream comprises the second organic extraction solution and a second extracted solvent combination, which comprising minor actinides, including americium and curium, and lanthanides. The formation of the second extraction stream partitions the minor actinides and the lanthanides from the remainder of the main process steam, which remains in aqueous phase and exits the first extraction bank 162 at the first end 163 and is directed to the additional subsystems the solvent extraction system 108, for example, the downstream metal extraction subsystem 190. The second extraction stream remains in organic phase, exits the first extraction bank 162 at the second end 164 and is directed to a second extraction bank 170 via a feed path 167, which fluidly couples the first extraction bank 162 and the second extraction bank 170. The second extraction bank 170 comprises a first end 171 opposite a second end 172, and a plurality of mixing devices 161. The feed path 167 is fluidly coupled to the second extraction bank 170, for example, to a mixing device 161 between the first end 171 and the second end 172, for example, at or near the center of the second extraction bank 170. The second extraction bank 170 further comprises an organic input 174 and an aqueous input 176. The organic input 174 is a fluid pathway for organic solution to be directed into the second extraction bank 170 and the aqueous input 176 is a fluid pathway for aqueous solution to be directed into the second extraction bank 170. The organic input 174 and the aqueous input 176 may comprise any fluid flow and control devices, such as piping, tubing, pumps, and tanks. In some embodiments, the organic input 174 is positioned at or near the first end 171 and the aqueous input 176 is positioned at or near the second end 172. The second extraction bank 170 further comprises a collection pathway 178 fluidly coupling one or more mixing devices 161 positioned at or near the first end 171 to a collection unit 179 and a collection pathway 180 fluidly coupling one or more mixing devices 161 positioned at or near the first end 171 to a collection unit 181.

In operation, the second extraction stream is directed into the second extraction bank 170 and a minor actinide stripping agent and a lanthanide stripping agent are selectively combined with the second extraction stream in the second extraction bank 170. For example, the second extraction stream is directed into the second extraction bank 170 between the first end 171 and the second end 172 and the minor actinide stripping agent is directed into the second end 172 of the second extraction bank 170 at the aqueous input 176 followed by the lanthanide stripping agent. In some embodiments, additional organic extraction solution (e.g., additional second organic extraction solution) is directed into the first end 171 of the second extraction bank 170, for example, at the organic input 174. The plurality of mixing devices 161 of the second extraction bank 170 direct the second extraction stream and any additional organic solution toward the second end 172 and direct the minor actinide stripping agent toward the first end 171, combining and agitating the minor actinide stripping agent and second first extraction stream using the mixing devices 161 such that the minor actinides are removed from the second extraction stream (which is in an organic phase) and combined with the minor actinide stripping agent (which is in an aqueous phase) to form a minor actinide aqueous solution. The lanthanide stripping agent follows behind the minor actinide stripping agent, such that the remainder of the second extraction stream is combined and agitated with the lanthanide stripping agent, such that the lanthanides are removed from the second extraction stream (which is in an organic phase) and combined with the lanthanide stripping agent (which is in an aqueous phase) to for a lanthanide aqueous solution.

In some embodiments, the minor actinide stripping agent comprises an acid and a pH altering molecular formation. Example acids of the minor actinide stripping agent include TEDGA, CDTA, pentetic acid, diethylene triamine pentaacetic acid (DTPA), hydroxyethylethylenediaminetriacetic acid (HEDTA), and acetohydroxamic acid (AHA). Example pH altering molecular formations of the minor actinide stripping agent include citrate, lactate, and malonate, which adjust the pH of the minor actinide stripping acid to a first pH, which may be a pH of from about 3.5 to about 4.5. In some embodiments, the lanthanide stripping agent comprises an acid a pH altering molecular formation. Example acids of the lanthanide stripping agent include TEDGA, CDTA, pentetic acid, diethylene triamine pentaacetic acid (DTPA), hydroxyethylethylenediaminetriacetic acid (HEDTA), and acetohydroxamic acid (AHA). Example pH altering molecular formations of the lanthanide stripping agent include citrate, lactate, and malonate, which adjust the pH of the minor actinide stripping acid to a second pH, which may be a pH of from about 4.0 to about 6.5, Indeed, the first pH (e.g., the pH of the minor actinide stripping agent) is lower that the second pH (the pH of the lanthanide stripping acid).

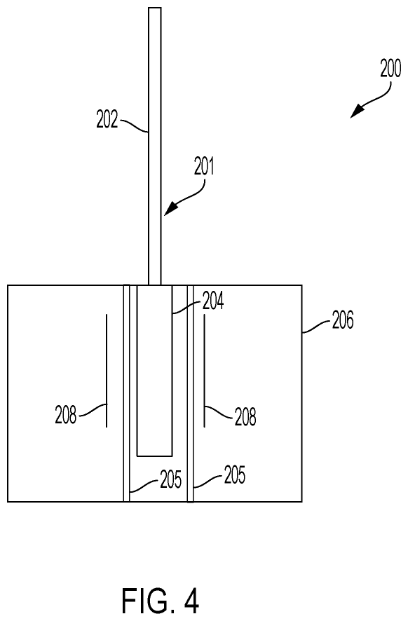

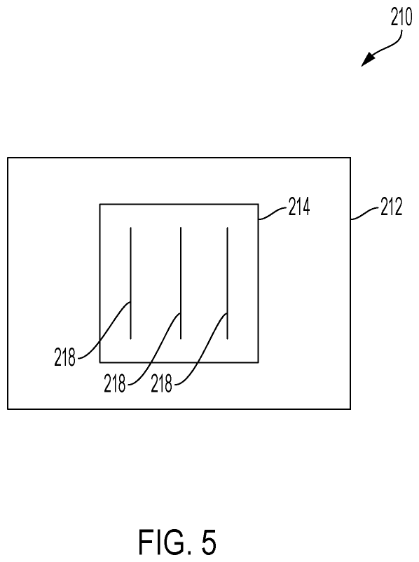

The minor actinide aqueous solution exits the second extraction bank 170, for example, at the first end 171, and is directed to a collection unit 179 via a collection pathway 178 for storage and, in some embodiments, additional processing. The lanthanide aqueous solution exits the third extraction bank 140, for example, at the first end 142 following the exit of the minor actinide aqueous solution and is directed to a collection unit 181 via a collection pathway 180 for storage and, in some embodiments, additional processing. After collection, the minor actinides may undergo transmutation, for example, fusion-based transmutation, which is described in more detail below with respect to FIGS. 4 and 5. After collection, the lanthanides may be further partitioned into individual lanthanide elements, some of which are valuable products.

Referring still to FIG. 3, the downstream metal extraction subsystem 190 is configured to selectively extract additional fission products that remain in the main process stream 101 downstream the actinide extraction subsystem 160. Indeed, used nuclear fuel represents an unconventional sources of high-value fission product derived elements, for example, noble metals, including palladium (Pd), ruthenium (Ru), platinum (Pt), gold (Au), and rhodium (Rh), as their concentration in used nuclear fuel can be on the order of a few weight percent. In some embodiments, the downstream metal extraction subsystem 190 comprises a liquid-liquid extraction system. For example, the downstream metal extraction subsystem 190 may comprise one or more extraction banks each comprising mixing devices similar to the extraction banks and the mixing devices described above with respect to the uranium extraction subsystem 110 and the actinide extraction subsystem 160. In operation, noble metals present in a nitric acid medium (e.g., present in the main process stream 101 exiting the first extraction bank 162 of the actinide extraction subsystem 160) may be selectively extracted from the main process stream 101 using organic extractants that have a chemical affinity in certain conditions for noble metals, for example, for example, neutral organophosphorus ligands or quaternary ammonium salts in the presence of 1-3 M nitric acid and hydrophilic hold back reagents. Indeed, different organic extractants can be introduced sequentially to selectively strip individual noble metals. This liquid-liquid extraction of noble metals may function as a bulk separation and may be followed by a precipitation or ion-exchange process to refine and increase the purity of the partitioned noble metals. Moreover, the downstream metal extraction subsystem 190 may extract other fission products and radioisotopes not previously captured or not previously captured completely by the voloxidation system 104, the dissolution system 106 and the solvent extraction system 108 (such as Sr-90 and Cs-137 in embodiments that do not include the fission product extraction subsystem 158). After passing through the downstream metal extraction subsystem 190, the remaining raffinate from the main process stream 101 is packaged as waste, either via vitrification or cementation depending on the final waste categorization.

Referring now to FIGS. 4 and 5, transmutation systems 200 and 210 are schematically depicted, respectively. Transmutation systems 200 and 210 are each configured to transmute minor actinides partitioned from used nuclear fuel by neutron irradiation, for example, the minor actinides partitioned from used nuclear fuel using the actinide extraction subsystem 160 of FIG. 3. Indeed, past studies have showed that the separation of minor actinides from used nuclear fuel would reduce the total repository volume of stored used nuclear fuel by up to a factor of seven. Americium (²⁴¹Am) and curium (²⁴⁴Cm), in particular, contribute a significant amount of decay heat when considering vitrification and long-term storage. The transmutation systems 200, 210 may be used for the transmutation of minor actinides partitioned from used nuclear fuel, such as ²⁴¹Am and ²⁴⁴Cm. It should be understood that the transmutation systems 200, 210 described herein may be used to transmute other minor actinide isotopes. Transmuting the one or more minor actinides may be performed using neutron irradiation. The neutron irradiation may occur using an accelerator-based system, for example, an accelerator-based system that generates neutrons by fusion, such as DT fusion, such as the transmutation system 200 of FIG. 4, or another accelerator based fusion system. The neutron irradiation may be performed in a nuclear reactor, such as the transmutation system 210 of FIG. 5, which may comprise a power reactor, a research reactor, or any other known or yet to be developed nuclear reactor. It is contemplated that the transmutation process may also generate energy.

Referring now to FIG. 4, the transmutation system 200 of FIG. 4 comprises a neutron generator 201 comprising a beam accelerator 202 and a target chamber 204. The beam accelerator 202 is generates and accelerates an ion beam, for example, a beam of deuterium ions, and directs the ion beam into the target chamber 204. The target chamber 204 houses a target, such as tritium gas, which interacts with the deuterium beam to cause a fusion reaction (e.g., a deuterium-tritium fusion reaction) and generates neutrons via the fusion reaction. The transmutation system 200 further comprises an irradiation chamber 206 positioned proximate the target chamber 204, for example, surrounding the target chamber 204. Positioning the irradiation chamber 206 such that it surrounds the target chamber 204 may increasing the likelihood that fusion generated neutrons will reach the irradiation chamber 206 and irradiate the one or more minor actinides The one or more minor actinides (depicted as minor actinide targets 208 in FIG. 4) may be positioned in the irradiation chamber 206 while neutrons are generated in the target chamber 204 such that the neutrons irradiate the one or more minor actinides, thereby fissioning at least a portion of the the one or more minor actinides. The neutrons may irradiate the one or more minor actinides in the irradiation chamber 206 for a sufficient irradiation period to cause transmutation of the one or more minor actinides via fission. In some embodiments, the one or more minor actinides are in a solution form in the irradiation chamber.

The method of transmuting the one or more minor actinides may further comprise multiplying the fusion generated neutrons through subcritical multiplication, for example, subcritical multiplication to generate fast neutrons. In operation, subcritical multiplication generates fast neutrons that, together with the fusion generated neutrons, irradiate the one or more minor actinides in the irradiation chamber 206. In some embodiments, this subcritical multiplication may occur naturally due the high fissionability of some minor actinides, such as ²⁴¹Am and curium (²⁴⁴Cm). In some embodiments, a multiplier 205 is positioned between the target chamber 204 and the irradiation chamber 206 and is configured to sub-critically multiply the fusion generated neutrons. In some embodiments, the multiplier 205 comprises beryllium. In some embodiments, the multiplier 205 is positioned surrounding the irradiation chamber 206 and operates to reflect neutrons back towards the minor actinides present in the irradiation chamber 206.

Referring now to FIG. 5, the transmutation system 210 is a reactor-based transmutation system. The transmutation system 210 comprises a reactor 212 with a core 214. The one or more one more minor actinide targets 218 depicted in FIG. 5 may comprise irradiation rods with one or more minor actinides positioned in or on the irradiation rods. These irradiation rods may be positioned in the reactor 212, for example, in the core 214 of the reactor 212. Indeed, in some embodiments, transmuting the one or more minor actinides comprises positioning the one or more minor actinides in an irradiation rod configured to be inserted into reactor 212, positioning the irradiation rod (e.g., the one or more minor actinide targets 218 in the reactor 212, and irradiating the irradiation rod and the one or more minor actinides with neutrons generated in the reactor 212. For example, the irradiation rod may be positioned in a control rod tube or an instrumentation tube and may be retained in the nuclear reactor for a sufficient irradiation period to cause transmutation of the one or more minor actinides, for example, by fissioning the one or more minor actinides.

Other example systems that may be used in the transmutation process include molten salt fast reactor systems and fusion-driven molten salt subcritical fast systems, and metal based fast reactor systems. Indeed, in some embodiments, the fusion neutron source (which may be an accelerator-based source or other fusion neutron source) radiates outward from a plasma vessel that contains the fusion chamber (e.g., a subcritical blanket). The fusion generated neutrons pass outward into a molten salt or liquid metal subcritical multiplication system, which could contain heterogeneous distributed rods of minor actinides (e.g., Am/Cm) or a homogenous minor actinide (e.g., Am/Cm) solution where the solvent is liquid metal or molten salt. In some embodiments, a multiplier is positioned proximate the target chamber and the irradiation chamber (e.g., between the target chamber and the irradiation chamber, radially adjacent the irradiation chamber, or the like) and is configured to perform subcritical multiplication of the fusion generated neutrons.

Using any of the transmutation techniques described above, other isotopes collected using the fuel processing system 100 of FIGS. 1-3 could transmuted. For example, the partitioned and collected Np-237 could be neutron irradiated using the above techniques to cause neutron capture. When Np-237 captures a neutron, it becomes Np-238 for a 2.1 day half life, and then decays into Pu-238, which has an 87.7 year half life and has use as a battery for space travel. Other isotopes partitioned using the fuel processing system 100 of FIGS. 1-3 that could transmuted using the above techniques include, but are not limited to, Tc-99 and I-129.

According to a first aspect of the present disclosure, a method of processing used nuclear fuel includes voloxidizing used nuclear fuel pellets to form a used nuclear fuel powder; dissolving the used nuclear fuel powder in a dissolution acid to form a main process stream; extracting uranium (U), plutonium (Pu), neptunium (Np), and technetium (Tc) from the main process stream to form a first extraction stream; partitioning the first extraction stream into a U/Pu/Np stream and a U/Tc stream; partitioning the U/Pu/Np stream into Np and a U/Pu combination; partitioning one or more minor actinides and one or more lanthanides from the main process stream to form a second extraction stream; partitioning the one more minor actinides from the one or more lanthanides in the second extraction stream; and partitioning one or more noble metals from the main process stream.

A second aspect includes the first aspect, wherein the one or more noble metals are partitioned after partitioning the one or more minor actinides and one or more lanthanides from the main process stream.

A third aspect includes the first aspect or the second aspect, further comprising partitioning the U/Tc stream into U and Tc.

A fourth aspect includes any of the previous aspects, wherein the one or more minor actinides comprise ²⁴¹Am and ²⁴⁴Cm.

A fifth aspect includes any of the previous aspects, further comprising transmuting the one or more minor actinides using neutron irradiation.

A sixth aspect includes the fifth aspect, wherein transmuting the one or more minor actinides comprises positioning the one or more minor actinides in an irradiation rod configured to be inserted into a nuclear reactor, positioning the irradiation rod in the nuclear reactor, and irradiating the irradiation rod and the one or more minor actinides with neutrons generated in the nuclear reactor.

A seventh aspect includes the fifth aspect, wherein transmuting the one or more minor actinides comprises positioning the one or more minor actinides in an irradiation chamber located proximate a target chamber of a neutron generator and generating neutrons via a fusion reaction in the target chamber of the neutron generator such that the neutrons irradiate the one or more minor actinides in the irradiation chamber, thereby fissioning at least a portion of the one or more minor actinides.

An eighth aspect includes the seventh aspect, further comprising multiplying the fusion generated neutrons through subcritical multiplication.

A ninth aspect includes the seventh aspect or the eighth aspect, wherein a multiplier is positioned between the target chamber and the irradiation chamber and is configured to perform subcritical multiplication of the fusion generated neutrons.

A tenth aspect includes the seventh through ninth aspects, wherein the subcritical multiplication generates fast neutrons that, together with the fusion generated neutrons, irradiate the one or more minor actinides in the irradiation chamber.

An eleventh aspect includes the seventh through tenth aspects, wherein generating neutrons comprises accelerating an ion beam from a beam accelerator into the target chamber such that the ion beam interacts with a target to generate the neutrons via a fusion reaction.

A twelfth aspect includes the eleventh aspect, wherein the ion beam comprises a deuterium beam and the target comprises tritium.

A thirteenth aspect includes the seventh through twelfth aspects, wherein the irradiation chamber surrounds the target chamber.

A fourteenth aspect includes any of the previous aspects, further comprising partitioning cesium and strontium from the main process stream.

A fifteenth aspect includes the fourteenth aspect, wherein cesium and strontium are partitioned from the main process stream prior to partitioning the one or more noble metals.

A sixteenth aspect includes the fourteenth or the fifteenth aspect, wherein cesium and strontium are partitioned from the main process stream prior to partitioning the one or more minor actinides and the one or more lanthanides.

A seventeenth aspect includes any of the previous aspects, wherein voloxidizing the used nuclear fuel pellets comprises heating the pellets of used nuclear fuel to a temperature in a range of from 300 °C to 650 °C in the presence of NO₂, O₂, air, and H₂O.

An eighteenth aspect includes any of the previous aspects, wherein voloxidizing the used nuclear fuel pellets removes one or more volatile fission products from the used nuclear fuel.

A nineteenth aspect includes the eighteenth aspect, further comprising capturing the one or more volatile fission products.

A twentieth aspect includes the eighteenth or nineteenth aspects, wherein the one or more volatile fission products removed from the used nuclear fuel comprise tritium, xenon, iodine, ¹⁴CO₂, and krypton.

A twenty-first aspect includes any of the previous aspects, wherein the dissolution acid comprises nitric acid.

According to a twenty-second aspect of the present disclosure, a method of processing used nuclear fuel includes combining a first organic extraction solution with a main process stream, the main process stream comprising used nuclear fuel; agitating the main process stream and the first organic extraction solution using a solvent extraction system such that a first extraction stream is partitioned from the main process stream, wherein the first extraction stream comprises the first organic extraction solution and a first extracted solvent combination, the first extracted solvent combination comprising uranium (U), plutonium (Pu), neptunium (Np), and technetium (Tc); partitioning the first extraction stream, wherein partitioning the first extraction stream comprises adding a first aqueous removal agent to the first extraction stream and agitating the first extraction stream with the solvent extraction system such that the first extraction stream partitions into a U/Pu/Np aqueous solution and a U/Tc organic solution; adding additional first organic extraction solution and a second aqueous removal agent to the U/Pu/Np aqueous solution and agitating the U/Pu/Np aqueous solution with the solvent extraction system such that the U/Pu/Np solution partitions into a U/Pu organic solution and an Np aqueous solution; directing a nitric acid solution into the U/Tc organic solution and agitating the U/Tc organic solution with the solvent extraction system such that the U/Tc organic solution partitions into a U/Tc aqueous solution; and partitioning the U/Tc aqueous solution into U and Tc.

A twenty-third aspect includes the twenty-second aspect, wherein the solvent extraction system comprises a uranium extraction subsystem comprising one or more extraction banks each comprising a plurality of mixing devices.

A twenty-fourth aspect includes the twenty-third aspect, wherein the plurality of mixing devices comprise centrifugal contactors, pulse columns, mixer settlers, or a combination thereof.

A twenty-fifth aspect includes the twenty-third or twenty-fourth aspect, wherein the first extraction stream is partitioned from the main process stream using a first extraction bank of the uranium extraction subsystem; the first extraction stream partitions into the U/Pu/Np aqueous solution and the U/Tc organic solution using a second extraction bank of the uranium extraction subsystem; the U/Pu/Np solution partitions into the U/Pu organic solution and the Np aqueous solution using a third extraction bank of the uranium extraction subsystem; and the U/Tc organic solution partitions into the U/Tc aqueous solution and a remaining organic solution using a fourth extraction bank of the uranium extraction subsystem.

A twenty-sixth aspect includes any of the twenty-second through twenty-fifth aspects, wherein the first organic extraction solution comprises an organo-phosphorus extractant and a hydrocarbon diluent.

A twenty-seventh aspect includes the twenty-sixth aspect, wherein the organo-phosphorous extractant comprises tributyl phosphate (TBP).

A twenty-eighth aspect includes any of the twenty-second through twenty-seventh aspects, wherein the first aqueous removal agent comprises nitric acid and one or more oxidation state modifiers.

A twenty-ninth aspect includes the twenty-eighth aspect, wherein the one or more oxidation state modifiers of the first aqueous removal agent comprise U(IV) and N₂H₅NO₃.

A thirtieth aspect includes the any of the twenty-second through twenty-ninth aspects, wherein the second aqueous removal agent comprises nitric acid and one or more oxidation state modifiers.

A thirty-first aspect includes the thirtieth aspect, wherein the one or more oxidation state modifiers of the second aqueous removal agent comprise U(IV) and N₂H₅NO₃.

A thirty-second aspect includes the thirtieth aspect, wherein the one or more oxidation state modifiers of the second aqueous removal agent comprise V(V) and FeSO₄.

A thirty-third aspect includes any of the twenty-second through thirty-second aspects, wherein partitioning the U and Tc comprises interacting the U/Tc aqueous solution with an ion exchange column such that Tc adsorbs onto an ion exchange material of the ion exchange column and a U aqueous solution exits the ion exchange column.

A thirty-fourth aspect includes the thirty-third aspect, further comprising resorbing Tc from ion exchange column using a nitric acid and separating the Tc from the nitric acid by calcination or precipitation.

A thirty-fifth aspect includes the thirty-third or thirty-fourth aspect, further comprising separating the U from the U aqueous solution by calcination or precipitation.

A thirty-sixth aspect includes any of the twenty-second through thirty-fifth aspects, further comprising, prior to combining the first organic extraction solution with the main process stream: voloxidizing pellets of used nuclear fuel to form a used nuclear fuel powder; and dissolving the used nuclear fuel powder in a dissolution acid to form the main process stream.

A thirty-seventh aspect includes the thirty-sixth aspect, wherein the pellets of used nuclear fuel are voloxidized using a voloxidation system, the voloxidation system comprising a voloxidation furnace and an off-gas system, the off-gas system fluidly coupled to the voloxidation furnace.

A thirty-eighth aspect includes the thirty-sixth or thirty-seventh aspect, wherein the used nuclear fuel powder is dissolved in a dissolution tank.

A thirty-ninth aspect includes any of the twenty-second through thirty-eighth aspects, further comprising combining a second organic extractant solution with the main process stream and agitating the main process stream using the solvent extraction system such that a second extraction stream is partitioned from the main process stream, wherein the second extraction stream comprises the second organic extractant solution and a second extracted solvent combination, the second extracted solvent combination comprising one or more minor actinides and one or more lanthanides; partitioning the one or more minor actinides from the second extraction stream; and partitioning the one or more lanthanides from the second extraction stream.

A fortieth aspect includes the thirty-ninth aspect, wherein the second organic extractant solution comprises organic neutral extractant and an acidic extractant.

A forty-first aspect includes the thirty-ninth or fortieth aspect, wherein partitioning the one or more minor actinides from the second extraction stream comprises adding a minor actinide stripping agent to the second extraction stream and agitating the second extraction stream with the solvent extraction system such that the one or more minor actinides partition from the second extraction stream into a minor actinide aqueous stream; and partitioning the one or more lanthanides from the second extraction stream comprises adding a lanthanide stripping agent to the second extraction stream and agitating the second extraction stream with the solvent extraction system such that the one or more lanthanides partition from the second extraction stream into a lanthanide aqueous stream.

A forty-second aspect includes the forty-first aspect wherein the minor actinide stripping agent comprises a first pH, the lanthanide stripping agent comprises a second pH, and the first pH is lower than the second pH.

A forty-third aspect includes any of the thirty-ninth through forty-second aspects, wherein the solvent extraction system comprises an actinide extraction subsystem comprising one or more extraction banks each comprising a plurality of mixing devices.

A forty-fourth aspect includes the forty-third aspect, wherein the plurality of mixing devices comprise centrifugal contactors, pulse columns, mixer settlers, or a combination thereof.

A forty-fifth aspect includes the forty-third or forty-fourth aspects, wherein the second extraction stream is partitioned from the main process stream using a first extraction bank of the actinide extraction subsystem; the one or more actinides are partitioned from the second extraction stream using a second extraction bank of the actinide extraction subsystem; and the one or more lanthanides are partitioned from the second extraction stream using the second extraction bank of the actinide extraction subsystem.

A forty-sixth aspect includes any of the thirty-ninth through forty-fifth aspects, wherein the one or more minor actinides comprise ²⁴¹Am and ²⁴⁴Cm.

A forty-seventh aspect includes any of the thirty-ninth through forty-sixth aspects, further comprising transmuting the one or more minor actinides using neutron irradiation.

A forty-eighth aspect includes the forty-seventh aspect, wherein transmuting the one or more minor actinides comprises positioning the one or more minor actinides in an irradiation rod configured to be inserted into a nuclear reactor, positioning the irradiation rod in the nuclear reactor; and irradiating the irradiation rod and the one or more minor actinides with neutrons generated in the nuclear reactor.

A forty-ninth aspect includes the forty-seventh aspect, wherein transmuting the one or more minor actinides comprises positioning the one or more minor actinides in an irradiation chamber located proximate a target chamber of a neutron generator; and generating neutrons via a fusion reaction in the target chamber of the neutron generator such that the neutrons irradiate the one or more minor actinides in the irradiation chamber, thereby fissioning at least a portion of the one or more minor actinides.

A fiftieth aspect includes the forty-ninth aspect, further comprising multiplying the fusion generated neutrons through subcritical multiplication.

A fifty-first aspect includes the forty-ninth or fiftieth aspect, wherein a multiplier is positioned between the target chamber and the irradiation chamber and is configured to perform subcritical multiplication of the fusion generated neutrons.

A fifty-second aspect includes any of the forty-ninth through fifty-first aspects, wherein, wherein the subcritical multiplication generates fast neutrons that, together with the fusion generated neutrons, irradiate the one or more minor actinides in the irradiation chamber.

A fifty-third aspect includes any of the forty-ninth through fifty-second aspects, wherein generating neutrons comprises accelerating an ion beam from a beam accelerator into the target chamber such that the ion beam interacts with a target to generate the neutrons via a fusion reaction.

A fifty-fourth aspect includes the fifty-third aspect, wherein the ion beam comprises a deuterium beam and the target comprises tritium.

A fifty-fifth aspect includes the fifty-third or fifty-fourth aspects, wherein the irradiation chamber surrounds the target chamber.

A fifty-sixth aspect includes any of the twenty-second through fifty-fifth aspects, further comprising partitioning one or more noble metals from the main process stream using liquid-liquid extraction.

A fifty-seventh aspect includes any of the any of the twenty-second through fifty-sixth aspects, further comprising further comprising partitioning cesium and strontium from the main process stream.

According to a fifty-eighth aspect of the present disclosure, a method of processing used nuclear fuel includes combining a first organic extraction solution with a main process stream, the main process stream comprising used nuclear fuel; agitating the main process stream and the first organic extraction solution using a solvent extraction system such that a first extraction stream is separated from the main process stream, wherein the first extraction stream comprises the first organic extraction solution and a first extracted solvent combination, the first extracted solvent combination comprising uranium (U), plutonium (Pu), neptunium (Np), and technetium (Tc); partitioning the first extraction stream, wherein partitioning the first extraction stream comprises adding a first aqueous removal agent to the first extraction stream and agitating the first extraction stream with the solvent extraction system such that the first extraction stream separates into a U/Pu/Np aqueous solution and a U/Tc organic solution; adding additional first organic extraction solution and a second aqueous removal agent to the U/Pu/Np aqueous solution and agitating the first extraction stream with the solvent extraction system such that the U/Pu/Np solution separates into a U/Pu organic solution and an Np aqueous solution; directing a nitric acid solution into the U/Tc organic solution and agitating the U/Tc organic solution with the solvent extraction system such that the U/Tc organic solution separates into a U/Tc aqueous solution; and interacting the U/Tc aqueous solution with an ion exchange column such that Tc adsorbs onto an ion exchange material of the ion exchange column; and the method further includes combining a second organic extractant solution with the main process stream and agitating the main process stream using the solvent extraction system such that a second extraction stream is separated from the main process stream, wherein the second extraction stream comprises the second organic extractant solution and a second extracted solvent combination, the second extracted solvent combination comprising one or more actinides and one or more lanthanides; partitioning the one or more actinides from the second extraction stream; partitioning the one or more lanthanides from the second extraction stream; and partitioning one or more noble metals from the main process stream.

A fifty-ninth aspect includes the fifty-eighth aspect, further comprising, prior to combining the first organic extraction solution with the main process stream: voloxidizing pellets of used nuclear fuel to form a used nuclear fuel powder; and dissolving the used nuclear fuel powder in a dissolution acid to form the main process stream.

A sixtieth aspect includes the fifty-eighth or fifty-ninth aspects, further comprising transmuting the one or more minor actinides using neutron irradiation.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. Thus, it is intended that the specification cover the modifications and variations of the various embodiments described herein provided such modification and variations come within the scope of the appended claims and their equivalents.

As utilized herein, the terms “approximately,” “about,” “substantially”, and similar terms are intended to have a broad meaning in harmony with the common and accepted usage by those of ordinary skill in the art to which the subject matter of this disclosure pertains. Indeed, such terms refer to the subsequently listed property or measurement within normal manufacturing tolerances and imperfections in the relevant field. It should be understood by those of skill in the art who review this disclosure that these terms are intended to allow a description of certain features described and claimed without restricting the scope of these features to the precise numerical values or idealized geometric forms provided. Accordingly, these terms should be interpreted as indicating that insubstantial or inconsequential modifications or alterations of the subject matter described and claimed are considered to be within the scope of the disclosure as recited in the appended claims.

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References herein to the positions of elements (e.g., “top,” “bottom,” “above,” “below”) are merely used to describe the orientation of various elements in the FIGURES. It should be noted that the orientation of various elements may differ according to other exemplary embodiments, and that such variations are intended to be encompassed by the present disclosure.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

1. A method of processing used nuclear fuel, the method comprising:
voloxidizing used nuclear fuel pellets to form a used nuclear fuel powder;
dissolving the used nuclear fuel powder in a dissolution acid to form a main process stream;
extracting uranium (U), plutonium (Pu), neptunium (Np), and technetium (Tc) from the main process stream to form a first extraction stream;
partitioning the first extraction stream into a U/Pu/Np stream and a U/Tc stream;
partitioning the U/Pu/Np stream into Np and a U/Pu combination;
partitioning one or more minor actinides and one or more lanthanides from the main process stream to form a second extraction stream;
partitioning the one more minor actinides from the one or more lanthanides in the second extraction stream; and
partitioning one or more noble metals from the main process stream.

2. The method of claim 1, wherein the one or more noble metals are partitioned after partitioning the one or more minor actinides and one or more lanthanides from the main process stream.

3. The method of claim 1, further comprising partitioning the U/Tc stream into U and Tc

4. The method of claim 1, wherein the one or more minor actinides comprise ²⁴¹Am and ²⁴⁴Cm.

5. The method of claim 1, further comprising transmuting the one or more minor actinides using neutron irradiation.

6. The method of claim 5, wherein transmuting the one or more minor actinides comprises:
positioning the one or more minor actinides in an irradiation rod configured to be inserted into a nuclear reactor;
positioning the irradiation rod in the nuclear reactor; and
irradiating the irradiation rod and the one or more minor actinides with neutrons generated in the nuclear reactor.

7. The method of claim 5, wherein transmuting the one or more minor actinides comprises:
positioning the one or more minor actinides in an irradiation chamber located proximate a target chamber of a neutron generator; and
generating neutrons via a fusion reaction in the target chamber of the neutron generator such that the neutrons irradiate the one or more minor actinides in the irradiation chamber, thereby fissioning at least a portion of the one or more minor actinides.

8-13. (canceled)

14. The method of claim 1, further comprising partitioning cesium and strontium from the main process stream.

15. The method of claim 14, wherein cesium and strontium are partitioned from the main process stream prior to partitioning the one or more noble metals.

16. The method of claim 14, wherein cesium and strontium are partitioned from the main process stream prior to partitioning the one or more minor actinides and the one or more lanthanides.

17. (canceled)

18. The method of claim 1, wherein voloxidizing the used nuclear fuel pellets removes one or more volatile fission products from the used nuclear fuel, and the method further comprises capturing the one or more volatile fission products, wherein the one or more volatile fission products removed from the used nuclear fuel comprise tritium, xenon, iodine, ¹⁴CO₂, krypton, or a combination thereof.

19-21. (canceled)

22. A method of processing used nuclear fuel, the method comprising:
combining a first organic extraction solution with a main process stream, the main process stream comprising used nuclear fuel;
agitating the main process stream and the first organic extraction solution using a solvent extraction system such that a first extraction stream is partitioned from the main process stream, wherein the first extraction stream comprises the first organic extraction solution and a first extracted solvent combination, the first extracted solvent combination comprising uranium (U), plutonium (Pu), neptunium (Np), and technetium (Tc);
partitioning the first extraction stream, wherein partitioning the first extraction stream comprises:
adding a first aqueous removal agent to the first extraction stream and agitating the first extraction stream with the solvent extraction system such that the first extraction stream partitions into a U/Pu/Np aqueous solution and a U/Tc organic solution;
adding additional first organic extraction solution and a second aqueous removal agent to the U/Pu/Np aqueous solution and agitating the U/Pu/Np aqueous solution with the solvent extraction system such that the U/Pu/Np solution partitions into a U/Pu organic solution and an Np aqueous solution;
directing a nitric acid solution into the U/Tc organic solution and agitating the U/Tc organic solution with the solvent extraction system such that the U/Tc organic solution partitions into a U/Tc aqueous solution; and
partitioning the U/Tc aqueous solution into U and Tc.

23-25. (canceled)

26. The method of claim 22, wherein the first organic extraction solution comprises an organo-phosphorus extractant and a hydrocarbon diluent.

27. The method of claim 26, wherein the organo-phosphorous extractant comprises tributyl phosphate (TBP).

28. The method of claim 22, wherein the first aqueous removal agent comprises nitric acid and one or more oxidation state modifiers comprising U(IV), N₂H₅NO₃, or combinations thereof.

29. (canceled)

30. The method of claim 22, wherein the second aqueous removal agent comprises nitric acid and one or more oxidation state modifiers comprising U(IV), N₂H₅NO₃. V(V), FeSO₄, or combinations thereof.

31-32. (canceled)

33. The method of claim 22, wherein partitioning the U and Tc comprises interacting the U/Tc aqueous solution with an ion exchange column such that Tc adsorbs onto an ion exchange material of the ion exchange column and a U aqueous solution exits the ion exchange column.

34-57. (canceled)

58. A method of processing used nuclear fuel, the method comprising:
combining a first organic extraction solution with a main process stream, the main process stream comprising used nuclear fuel;
agitating the main process stream and the first organic extraction solution using a solvent extraction system such that a first extraction stream is separated from the main process stream, wherein the first extraction stream comprises the first organic extraction solution and a first extracted solvent combination, the first extracted solvent combination comprising uranium (U), plutonium (Pu), neptunium (Np), and technetium (Tc);
partitioning the first extraction stream, wherein partitioning the first extraction stream comprises:
adding a first aqueous removal agent to the first extraction stream and agitating the first extraction stream with the solvent extraction system such that the first extraction stream separates into a U/Pu/Np aqueous solution and a U/Tc organic solution;
adding additional first organic extraction solution and a second aqueous removal agent to the U/Pu/Np aqueous solution and agitating the first extraction stream with the solvent extraction system such that the U/Pu/Np solution separates into a U/Pu organic solution and an Np aqueous solution;
directing a nitric acid solution into the U/Tc organic solution and agitating the U/Tc organic solution with the solvent extraction system such that the U/Tc organic solution separates into a U/Tc aqueous solution; and
interacting the U/Tc aqueous solution with an ion exchange column such that Tc adsorbs onto an ion exchange material of the ion exchange column;
combining a second organic extractant solution with the main process stream and agitating the main process stream using the solvent extraction system such that a second extraction stream is separated from the main process stream, wherein the second extraction stream comprises the second organic extractant solution and a second extracted solvent combination, the second extracted solvent combination comprising one or more actinides and one or more lanthanides;
partitioning the one or more actinides from the second extraction stream;
partitioning the one or more lanthanides from the second extraction stream; and
partitioning one or more noble metals from the main process stream.

59. The method of claim 58, further comprising, prior to combining the first organic extraction solution with the main process stream:
voloxidizing pellets of used nuclear fuel to form a used nuclear fuel powder; and
dissolving the used nuclear fuel powder in a dissolution acid to form the main process stream.

60. The method of claim 58, further comprising transmuting the one or more minor actinides using neutron irradiation.
